(19) United States
(12) Patent Application Publication
(10) Pub. No.: US 2007/0048409 A1
(43) Pub. Date: Mar. 1, 2007

(54) Container for liquid food products and procedure for packaging said liquid food products

(76) Inventors: Eros Bettini, Piovene Rocchette (VI) (IT); Erik Bettini, Piovene Rocchette (VI) (IT)

Correspondence Address: BIRCH STEWART KOLASCH & BIRCH, PO BOX 747, FALLS CHURCH, VA, 22040-0747, US

(21) Appl. No.: 10/589,365

(22) PCT Filed: Feb. 11, 2005
(86) PCT No.: PCT/IB05/00342

§ 371 Date: Aug. 14, 2006

(30) Foreign Application Priority Data
Feb. 16, 2004 (IT) VR2004A000017

(51) Int. Cl. A23B 7/148

(52) U.S. Cl. 426/106

(57) ABSTRACT

Container (10) for liquid or semi-liquid food products such as drinks, milk or similar, consisting of a hollow body provided with an upper closing element near the neck (12) and an open lower base (13) which is closed by a closing elements (15) only after the filling phases, said filling phases being performed via said base (13) and with the container turned upside down.

### FIELD OF APPLICATION

The present invention concerns a container for liquid or semi-liquid food products, in particular for milk, yogurt or similar, and the related procedure for packaging said liquid or semi-liquid food products.

More in particular, the present invention refers to a container for milk or other drinks, which can be stacked so as to minimise the dimensions for transport both prior to filling and after consumption.

The container manufactured according to the invention can be filled from the bottom, therefore turned upside down. In this way, the overturned container can be filled using any appropriately designed and economical filling machine, preferably linear but also rotary.

The present invention is applied in the sector of production of containers for drinks and more specifically containers for milk intended for firms which produce and directly package fresh liquid or semi-liquid food products on a daily basis.

### STATE OF THE ART

It is known that the packaging designed to contain liquid food such as milk, yogurt, fruit juices etc. is currently produced using certain standardised types. These types can be grouped into two main categories: packaging made of pre-cut multilayer cardboard or packaging consisting of the traditional plastic or glass bottles.

The packaging that uses pre-cut multilayer cardboard is produced by specific forming-filling machines via which, in a first phase, the cardboard is transformed into a container of a generally parallelepiped shape.

Once the container has been formed, open on one side, exclusively in the upper part of the direction of movement of the packages, it is filled by means of appropriate nozzles and hermetically closed, giving the packaging a particular shape.

This packaging, generally known as PUREPAK or TETRAREX, is produced exclusively by only a few firms at world level with huge energy consumption due to the complexity of the equipment.

This type of packaging is used mainly for liquid products with a limited shelf life (only a few days: 5-10-15), for example pasteurised fresh milk Another type of packaging, generally used for long-life liquid products, is known as TETRABRIK or TETRAPAK and is obtained from a continuous strip that forms the parallelepiped-shaped container, which is filled by the same machine. One of the problems posed by the known packaging machines used for both the PUREPAK and the TETRAPAK model, is the high cost due to their complexity; in fact the monopoly of them is in the hands of very few firms, which are often also the suppliers of the packaging.

Alternatively to this type of packaging, the traditional bottle is also found on the market. The liquid food is packed in plastic bottles for alimentary use or glass bottles of various shapes and sizes.

The glass or PET bottles, both returnable and disposable, are supplied by the factories that produce them, with high transport, storage and logistics costs. PET bottles or in any case bottles made of plastic can also be produced directly by the user, depending on the quantities required. Generally, however, they are produced and transported to the packaging plants with high costs, as they cannot be stacked.

A good solution is the PET bottle produced directly in line with the filling plant. In other words, preformed containers produced by any plastic processing firm are used, from which, upstream of the bottling plant, by means of appropriate blow moulding machines, the bottles are obtained. However, the use of this system is expedient only for large-scale production and in any case entails the use of complex and costly machinery.

As we have seen, the various types of containers that are generally found on the world market, i.e. the models PUREPAK and TETRAREX, the models TETRABRIK and TETRAPAK and the glass and plastic bottles in their various shapes and sizes on the one hand have the drawback of being not widely used due to the high cost of the plants and on the other are disadvantageous due to the high transport, storage and logistics costs.

### DESCRIPTION OF THE INVENTION

The present invention aims to offer a container which, due to its design and construction, represents a compromise between the cardboard container and the rigid container like the bottle, in such a way as to eliminate or at least reduce the drawbacks described above.

The invention also aims to provide a container for liquid food, such as drinks and in particular milk, which is easy to produce and is thus economically advantageous.

This is obtained by means of a container for liquid food, the characteristics of which are described in the main claim.

The dependent claims of the container for liquid food in question outline advantageous embodiments of the invention.

The container for liquid food manufactured according to the invention has the characteristic and the advantage of being designed and produced so that it can be stacked, in order to minimise the dimensions for transport.

Furthermore, it is characterised by the fact that the container is filled from the bottom, therefore turned upside down, so that the overturned container is filled by means of any appropriately designed and economical filling machine, preferably of the linear type.

A rotary filling machine can also be used, however, according to the same concept.

Once the container has been filled by the machine, its bottom is closed through the application of a heat-sealed base on which all the information required by law will be printed.

The reason why all the data and various information are provided on the bottom is due to the fact that, as is already known, on various occasions the packaging of food products on display in the shops has been tampered with, injecting harmful solutions into the neck of the bottles, mainly of mineral water, creating considerable health risks.

This container, on the other hand, enables the consumer to immediately check whether the packaging has been tampered with. In fact, when the consumer takes it from the shelf, in order to read the expiry date, for example, he/she is forced to turn the package upside down and can therefore immediately check that it is intact.

The financial advantages for a firm that wishes to invest in this production line are the following:
low investment cost for the machinery and for the production lines, therefore affordable also for small manufacturers;
lower cost of packaging as it can be stacked;
the cost of producing this type of packaging is lower than that of the multilayer cardboard packaging and glass or plastic bottles;
improved consumer safety, as any packaging that has been tampered with is immediately found out;
lower machinery maintenance costs, as the machines are simpler in construction terms than those currently used;
possibility of producing the new packaging in any part of the world and therefore also close to firms with high consumption.

Furthermore, the new container manufactured according to the invention is suitable for both large and small-scale production. The milk market, in particular the niche market, now also consists of small producers, who generally invest to market their product.

Many of them, however, cannot undertake the high cost of the packaging and the packaging machines, and are therefore prevented from starting up their own production line.

The main advantages offered by this solution consist, in short, in its maximum construction and production simplicity, with very simple and practical phases for packaging the liquid food product, and also in the fact that there is a clear saving in terms of management of the empty packages, both before they are filled and after consumption.

### DESCRIPTION OF THE DRAWINGS

Other characteristics and advantages of the invention will be highlighted in 20 greater detail in the description of one among many possible embodiments of the invention, provided as a non-limiting example with the aid of the attached drawings, wherein:

FIG. 1 is a schematic view in partial lateral cross section of the bottom part of the container according to the invention;

FIG. 2 shows a partial cross section of a plurality of empty containers stacked on top of one another;

FIG. 3 shows a detail of the upper part of the container provided with cap with pre-punched delivery tab;

FIG. 4 is a schematic plan view of the same;

FIGS. 5 and 6 are axonometric schematic views of the container according to the invention in a phase prior to the closing of the lower cover and in its finished form ready for consumption.

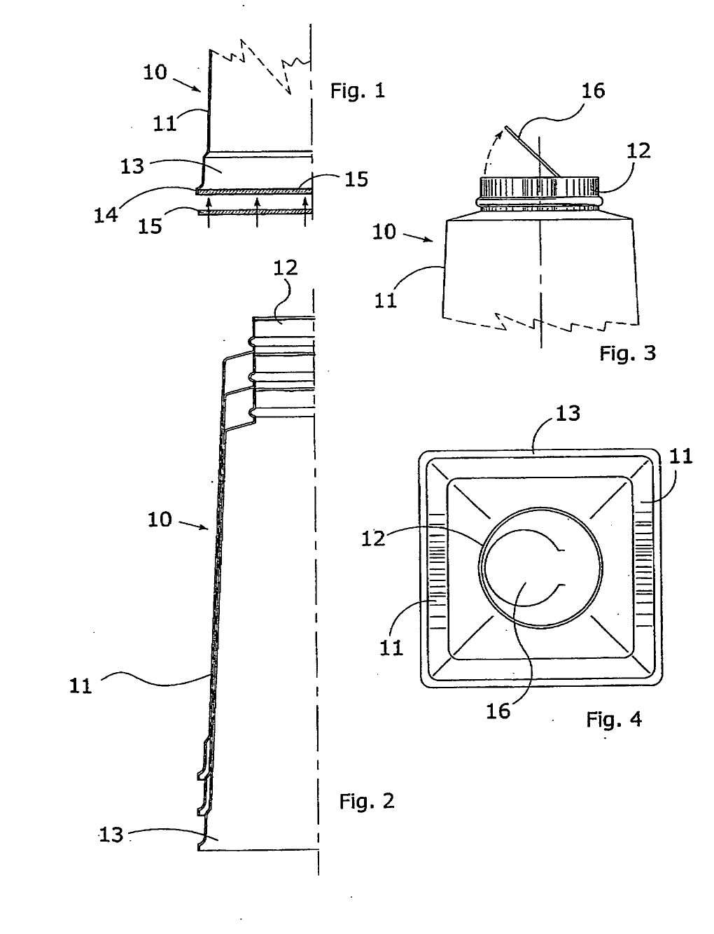

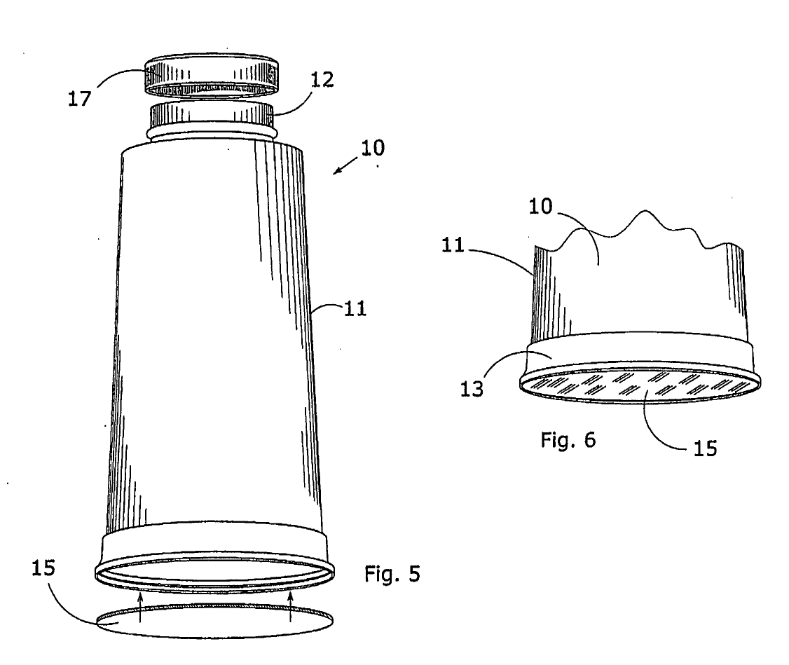

### DESCRIPTION OF AN EMBODIMENT OF THE INVENTION

The container according to the invention, indicated as a whole by 10, is produced in a shape that can be a parallelepiped with slanting sides or any other solid, that is, a prism, a cylinder, a truncated cone, a truncated pyramid or other.

The container 10, generally supplied with various capacities, for example 11, 0.751 or 0.51, has sides 11 arranged tapering slightly towards the upper part, where the neck 12 of the container is located.

The base 13 of the container is open, and has an edge 14 slightly protruding towards the outside.

The slight protrusion of the edge 14 of the base permits accommodation of the closing element 15 consisting of an insert with dimensions corresponding to the internal dimensions of the base.

The closing element 15 of the base is applied and heat-sealed on the base by means of specific equipment already known per se on the market, once the container has been filled with a liquid food product, for example milk.

The upper part of the container, at the level of the inlet of the neck 12, is provided with a flat part comprising a pre-punched tab 16.

Said tab, once opened by means of a slight finger pressure, provides an opening from which the liquid food product is delivered. The axis of the hole is eccentric to the axis of the bottle, to facilitate emptying of the liquid contained.

The tab 16 is raised only on one side and will form an integral part of the container. Once the required amount of product has been withdrawn, said tab is repositioned in order to close, not hermetically, the container.

The neck and the tab are closed by a cap 17, which is applied by pressure or in another more suitable way, to close the top of the bottle.

According to an advantageous embodiment of the invention, the cap can be produced in different colours to indicate, in the case of milk, the type of milk contained: for example blue cap for full cream milk, red cap for partially skimmed milk, yellow cap for high quality milk and green cap for sterile milk. Once the food product contained has been consumed, by exerting a pressure on one side of the closing element 15, an aperture is created which permits complete elimination of the base, so that the opened containers can be stacked once again. The procedure for filling the container therefore provides for the container to be fed into the filling machine in an overturned position, i.e. with the top cap resting facing downwards on the conveyor belt and with its base still open.

The filling machine will fill the overturned container with the liquid food product, until it almost reaches the brim, according to the established quantities. Once the filling phase has been completed, the filling machine provides automatically or via semi-automatic procedures for closing the base by heat-sealing and slight compression of the element 15, which will be fixed by heat on the edges of the base.

At this point the filled closed container can be taken out of the machine and upturned for positioning, this time upright, in the packages used for distribution. In any case it is a characteristic of the invention that the bottle is filled via the base, and therefore the bottle must be in an overturned position in the filling machine.

The container can be produced indifferently in any type of material suitable for food and coloured with relief impression of drawings and captions on the sides indicating type and origin.

As now appears clear and as highlighted previously, this packaging system allows the various containers to be stacked both before filling and after consumption by the user, with all the resulting advantages in terms of storage and disposal of the containers which can remain stacked.

The container manufactured according to the invention has been previously described with reference to a favourite embodiment. It is clear, however, that the invention is subject to numerous variations which fall within its scope, in the context of technical equivalents.

1.-5. (canceled)

6. A container for liquid or semi-liquid food products, comprising a hollow body provided with an upper closing element near the neck, an open lower base and a closing element adapted to close said base only after the filling phases, so that two or more of said containers can be stacked via the open base prior to said filling phases, said filling phases being performed via said base and with the container turned upside down, wherein once the food product contained in said container has been consumed, said base can be completely eliminated, so that one or more containers can be stacked again.

7. The container according to claim 6, wherein said base can be completely eliminated by exerting a pressure on one side of the closing element so as to create an aperture.

8. The container according to claim 6, wherein the body is substantially in the form of a prism, a cylinder, a truncated cone, or a truncated pyramid, in which the side walls are arranged slightly tapering towards the top, so as to facilitate stacking of two or more containers.

9. The container according to claim 6, wherein the upper part of the container, at the level of the inlet of the neck, is provided with a flat part comprising a pre-punched tab protected by a removable cap.

10. The container according to claim 6, wherein the element for closing the base is applied and heat-sealed onto the base by means of specific equipment, once the container has been filled with a liquid food product.
